(19) United States
(12) Patent Application Publication
(10) Pub. No.: US 2026/0034744 A1
(43) Pub. Date: Feb. 5, 2026

(54) POLYMER PROCESSING DEVICE AND PROCESS OF IMPLEMENTING THE SAME

(71) Applicant: Nordson Corporation, Westlake, OH (US)

(72) Inventors: Laurence B. SAIDMAN, Duluth, GA (US); Mark GOULD, Gainseville, GA (US); Les VARGA, Cumming, GA (US)

(73) Assignee: Nordson Corporation, Westlake, OH (US)

(21) Appl. No.: 18/997,592

(22) PCT Filed: Jul. 26, 2023
(86) PCT No.: PCT/US2023/070990

§ 371 Date: Jan. 22, 2025

Related U.S. Application Data
(60) Provisional application No. 63/392,564, filed on Jul. 27, 2022.

(51) Int. Cl. B29C 65/52; B29K 105/00; C09J 5/06

(52) U.S. Cl. CPC B29C 65/525; C09J 5/06; B29K 2105/0097

(57) ABSTRACT

A polymer processing device includes an extruder unit configured to receive, melt, and mix an adhesive and a dispensing valve unit configured to dispense adhesive onto a substrate. Additionally, the dispensing valve unit may include a positive displacement type valve that provides discrete dispensing of the adhesive.

### CROSS-REFERENCE TO RELATED APPLICATIONS

This application is a National Stage Application of International Patent App. No. PCT/US2023/070990, filed Jul. 26, 2023, which claims the benefit of U.S. Provisional Patent App. No. 63/392,564, filed Jul. 27, 2022, the entire disclosures of both of which are hereby incorporated by reference as if set forth in their entirety herein.

### FIELD OF THE DISCLOSURE

The disclosure relates to a polymer processing device. Additionally, the disclosure relates to a process of implementing a polymer processing device.

### BACKGROUND OF THE DISCLOSURE

Adhesives can be applied to various surfaces utilizing dispensing devices. These dispensing devices can dispense the adhesives, such as a filament adhesive, onto the various surfaces, such as surfaces of a substrate. FIG. 18 illustrates a typical dispensing device 1 for dispensing adhesive. The typical dispensing device 1 may use a barrel 2 that may include one or more heating elements. Additionally, the typical dispensing device 1 may include a rotatable screw 3 received in the barrel 2. Further, the typical dispensing device 1 may include an outlet 4 at a distal end of the barrel 2 for dispensing the adhesive in molten form from the typical dispensing device 1. Further, the typical dispensing device 1 may control the flow of the adhesive. In particular, the typical dispensing device 1 controls an operation of the rotatable screw 3 to control the flow of the adhesive dispensed from the outlet 4 of the typical dispensing device 1. Accordingly, the typical dispensing device 1 controls the flow of the adhesive dispensed from the outlet 4 based on a pressure of the adhesive provided by the rotatable screw 3.

Further, the typical dispensing device 1 may include a check valve 5. The check valve 5 is typically implemented with a closing member to block the flow. The closing member is spring-loaded to help keep the check valve 5 shut. Further, the typical dispensing device 1 may control the flow of the adhesive. In particular, the typical dispensing device 1 controls an operation of the rotatable screw 3 together with the check valve 5 to control the flow of the adhesive dispensed from the outlet 4 of the typical dispensing device 1. Accordingly, the typical dispensing device 1 controls the flow of the adhesive dispensed from the outlet 4 based on a pressure of the adhesive provided by the rotatable screw 3 in conjunction with the check valve 5.

However, controlling the flow of adhesive by the typical dispensing device 1 through operation of the rotatable screw 3 together with and/or without the check valve 5 results in undesired adhesive application. With reference to FIG. 19, an adhesive 7 has been applied to a substrate 8 with the typical dispensing device 1 through operation of the rotatable screw 3 together with the check valve 5. The result of this application of the adhesive 7 is poor cut off 9 due to the ‘stretchiness’ of the material; this application of the adhesive 7 is poor even in a molten state; this application of the adhesive 7 has less precise metering as illustrated by the end portions 11, which includes starting end portions and ending end portions, and the thick portions 12; and accordingly this application of the adhesive 7 realizes less precise dispensing. In this regard, the typical dispensing device 1 is primarily operating, for example using the check valve 5 and/or the rotatable screw 3, based on pressure.

Accordingly, what is needed is a dispensing device and/or a dispensing device process having better cut off, more precise metering, and more precise dispensing.

### SUMMARY

In one general aspect, a polymer processing device may include an extruder unit configured to receive, melt, and mix an adhesive, a dispensing valve unit configured to dispense adhesive onto a substrate, and where the dispensing valve unit may include a positive displacement type valve that provides discrete dispensing of the adhesive.

In one general aspect, a polymer processing device may include an extruder unit configured to receive, melt, and mix an adhesive, a dispensing valve unit configured to dispense adhesive onto a substrate, and where the dispensing valve unit is configured to be implemented as a pneumatic valve, an electrically operated valve, a solenoid operated valve, and/or a hydraulically operated valve.

In one general aspect, a process may include implementing an extruder unit configured to receive, melt, and mix an adhesive, implementing a dispensing valve unit configured to dispense adhesive onto a substrate, and where the dispensing valve unit is configured to be implemented as a pneumatic valve, an electrically operated valve, a solenoid operated valve, and/or a hydraulically operated valve.

Various other features, details and advantages of the invention will become more readily apparent to those of ordinary skill in the art upon review of the following detailed description of the illustrative embodiments, taken in conjunction with the accompanying drawings.

### BRIEF DESCRIPTION OF THE DRAWINGS

FIG. 1 illustrates a perspective view of a polymer processing device according to aspects of the disclosure.

FIG. 2 illustrates a front view of a polymer processing device according to FIG. 1.

FIG. 3 illustrates a side view of a polymer processing device according to FIG. 1.

FIG. 4 illustrates a top view of a polymer processing device according to FIG. 1.

FIG. 5 illustrates another side view of a polymer processing device according to FIG. 1.

FIG. 6 illustrates a back view of a polymer processing device according to FIG. 1.

FIG. 7 illustrates a bottom view of a polymer processing device according to FIG. 1.

FIG. 8 illustrates a cross-sectional view of an exemplary implementation of polymer processing device according to FIG. 1.

FIG. 9 illustrates a partial cross-sectional view of the polymer processing device according to FIG. 8.

FIG. 10 illustrates a partial cross-sectional view of the polymer processing device according to FIG. 8.

FIG. 11 illustrates a partial cross-sectional view of the polymer processing device according to FIG. 8.

FIG. 12 illustrates a partial cross-sectional view of the polymer processing device according to FIG. 11.

FIG. 13 illustrates a partial cross-sectional view of the dispensing valve unit 200 according to FIG. 12.

FIG. 14 illustrates a side view of a polymer processing device according to FIG. 1.

FIG. 15 illustrates a side view of a polymer processing device according to FIG. 1.

FIG. 16 illustrates an exemplary process for implementing a polymer processing device according to aspects of the disclosure.

FIG. 17 illustrates application of adhesive to a substrate utilizing the polymer processing device of the disclosure.

FIG. 18 illustrates a typical dispensing device for dispensing adhesive.

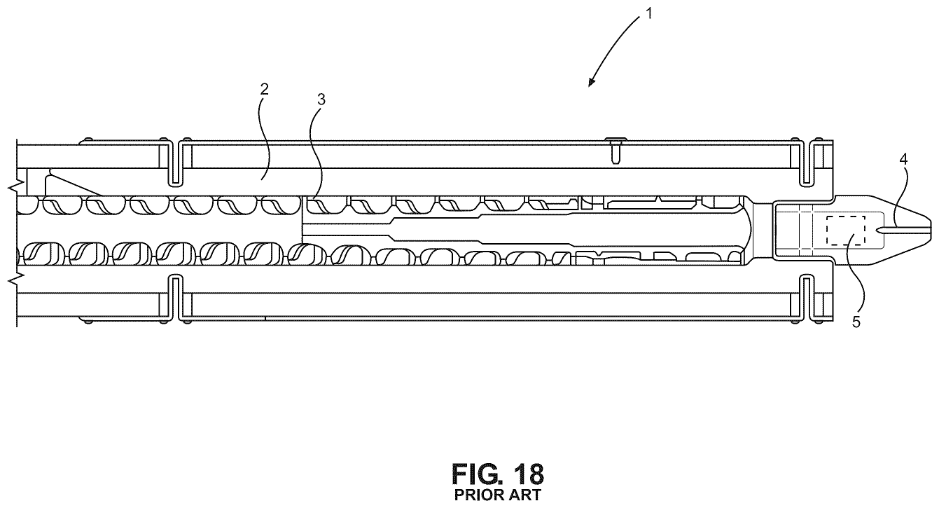

FIG. 19 illustrates an adhesive that has been applied to a substrate with the typical dispensing device.

### DETAILED DESCRIPTION OF THE ILLUSTRATIVE EMBODIMENTS

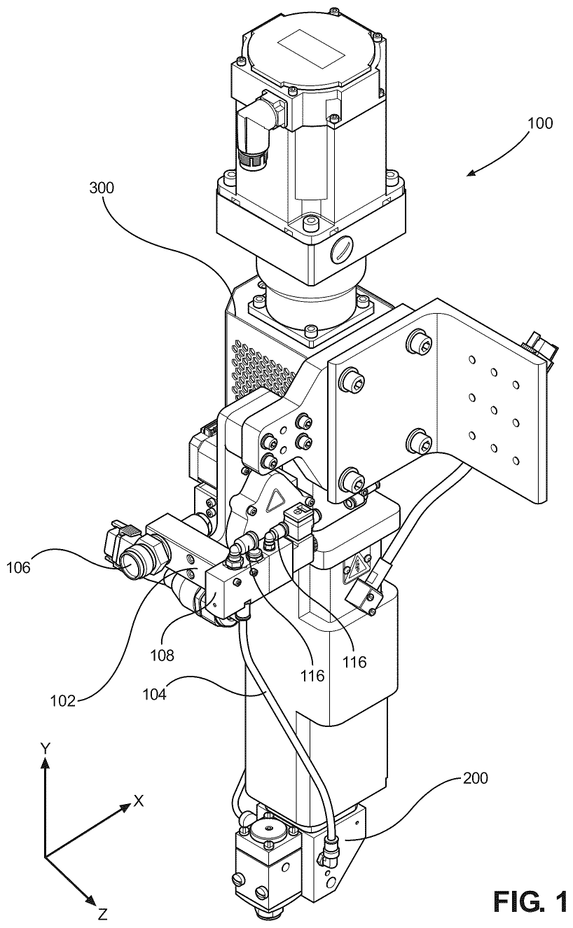

FIG. 1 illustrates a perspective view of a polymer processing device according to aspects of the disclosure.

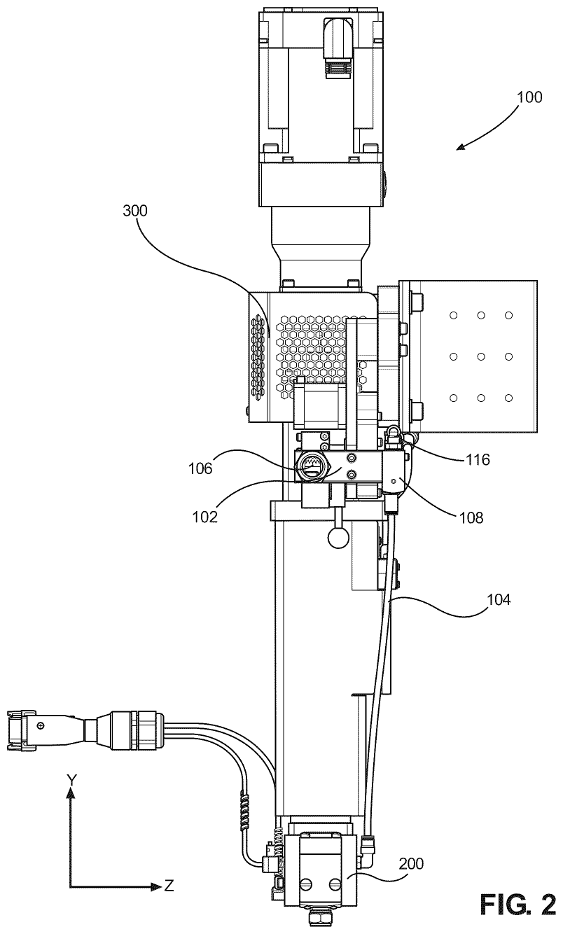

FIG. 2 illustrates a front view of a polymer processing device according to FIG. 1.

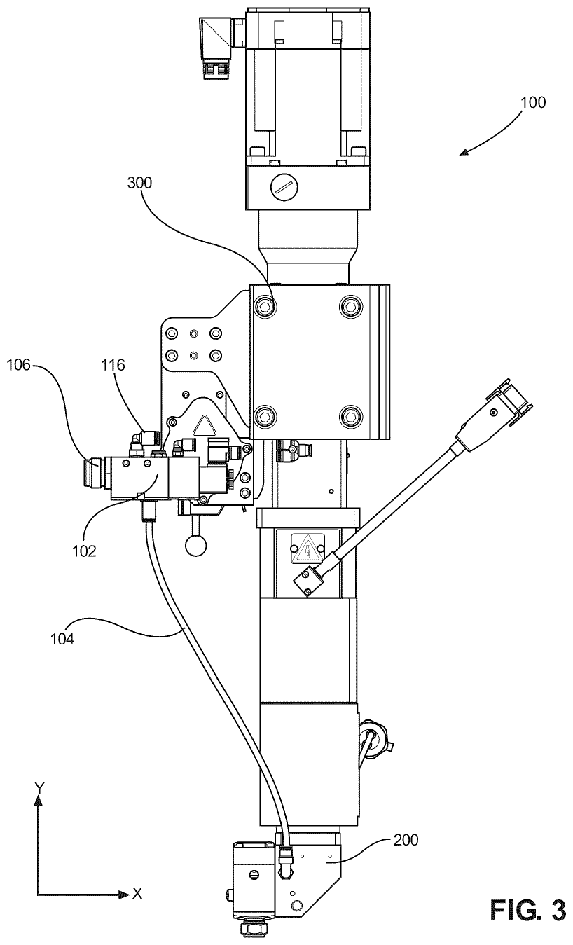

FIG. 3 illustrates a side view of a polymer processing device according to FIG. 1.

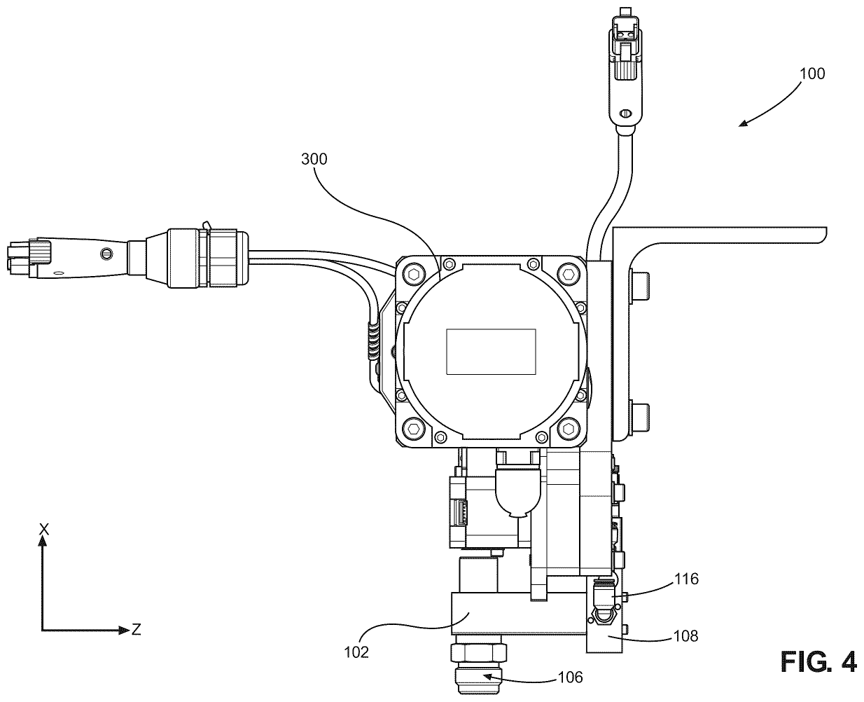

FIG. 4 illustrates a top view of a polymer processing device according to FIG. 1.

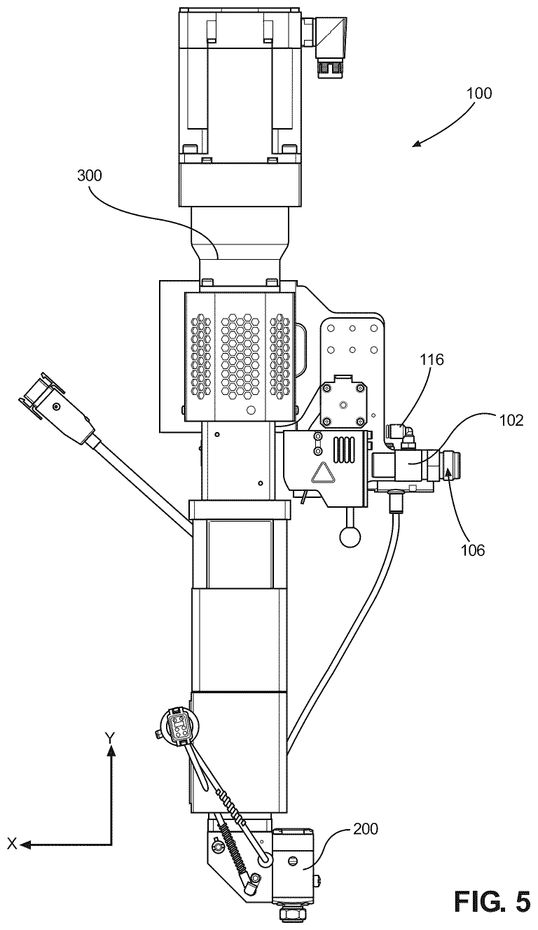

FIG. 5 illustrates another side view of a polymer processing device according to FIG. 1.

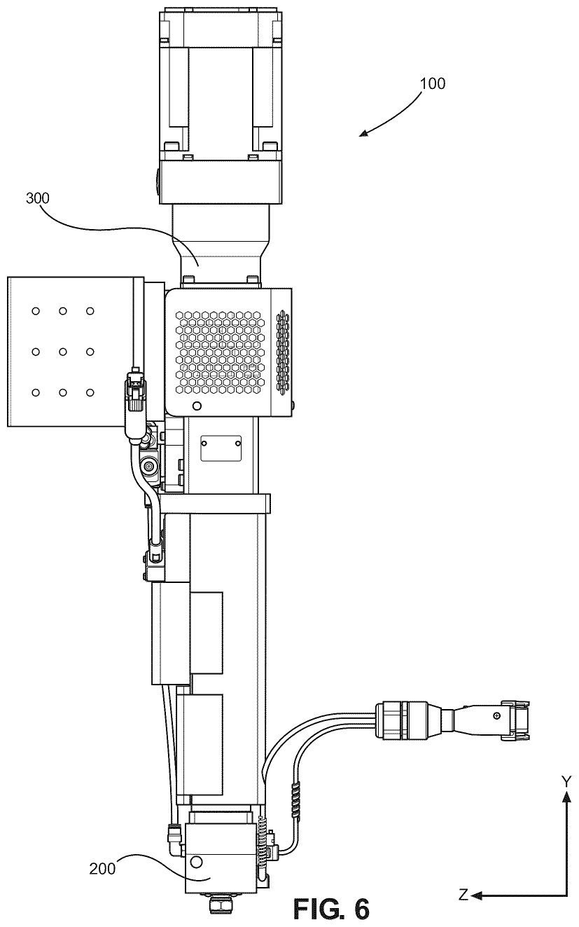

FIG. 6 illustrates a back view of a polymer processing device according to FIG. 1.

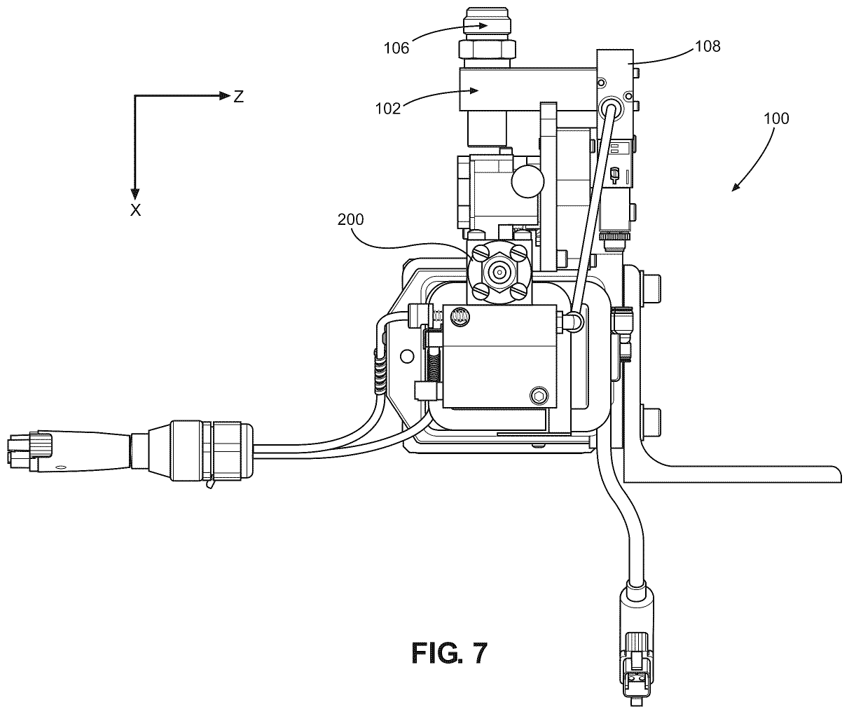

FIG. 7 illustrates a bottom view of a polymer processing device according to FIG. 1.

In particular, FIG. 1 illustrates a polymer processing device 100. The polymer processing device 100 includes a dispensing valve unit 200 and an extruder unit 300. The polymer processing device 100 is configured to operate in conjunction with the dispensing valve unit 200 and the extruder unit 300 to implement a configuration for receiving, melting, mixing, and dispensing adhesive, such as a filament adhesive, onto a substrate. In particular, the polymer processing device 100 is configured to operate in conjunction with the dispensing valve unit 200 to discreetly and accurately control dispensing of the adhesive received from the extruder unit 300.

In this regard, the dispensing valve unit 200 may be implemented to operate as a positive displacement type valve that provides discrete dispensing of the adhesive from the polymer processing device 100. More specifically, the polymer processing device 100 may be configured to operate the dispensing valve unit 200 to control the flow of adhesive for dispensing of the adhesive from the polymer processing device 100. In this regard, the polymer processing device 100 may implement the dispensing valve unit 200 to open and allow flow of adhesive generated by the extruder unit 300 to flow through the dispensing valve unit 200 for dispensing on a substrate; and the polymer processing device 100 may implement the dispensing valve unit 200 to close and stop a flow of adhesive generated by the extruder unit 300 through the dispensing valve unit 200 for cutting off a dispensing of the adhesive on a substrate.

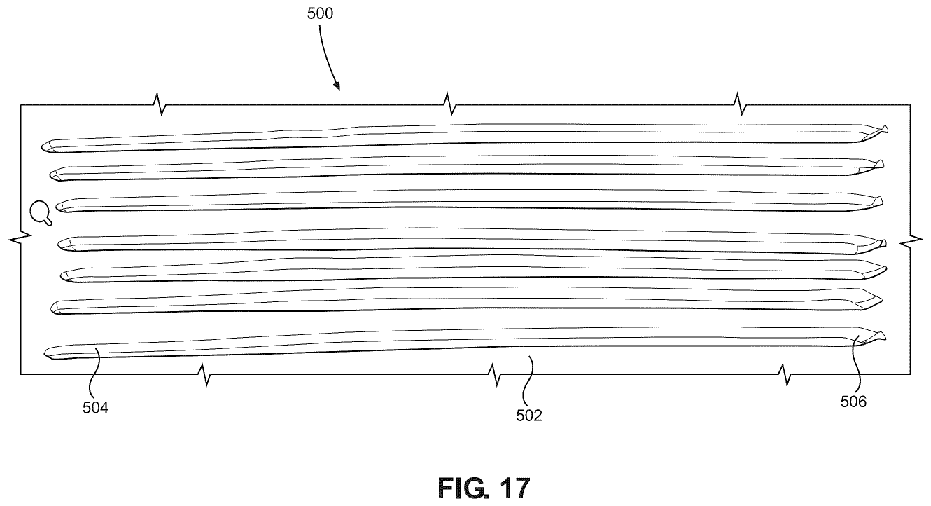

Accordingly, with reference to FIG. 17, the polymer processing device 100 is configured to operate in conjunction the dispensing valve unit 200 to apply an adhesive 500 to a substrate 502 with more controlled and/or more accurate start 506 of adhesive 500 at the end of a dispensing routine. Moreover, the polymer processing device 100 is configured to operate in conjunction the dispensing valve unit 200 to provide more controlled and/or more accurate cut off 504 of application of the adhesive 500 at the beginning of a dispensing routine. Moreover, the dispensing valve unit 200 is configured address the ‘stretchiness’ of the material by the positive displacement operation of the dispensing valve unit 200, even in the molten state.

Additionally, with reference to FIG. 17, the dispensing valve unit 200 is configured to provide more precise metering of the adhesive 500 from the extruder unit 300 of the polymer processing device 100 as illustrated by the more uniform width of the adhesive 500. In this regard, the polymer processing device 100 may implement the dispensing valve unit 200 to provide a more precise flow of the adhesive from the extruder unit 300. Accordingly, the dispensing valve unit 200 may be configured to provide precise metering of the adhesive from the extruder unit 300 by a controlled operation of the dispensing valve unit 200.

In aspects, the dispensing valve unit 200 of the polymer processing device 100 may be implemented as a pneumatic valve, an electrically operated valve, a solenoid operated valve, a hydraulically operated valve, and/or the like. It will be appreciated that the dispensing valve unit 200 and the polymer processing device 100 may be integrated together or coupled in any desired manner.

In aspects, the polymer processing device 100 and/or the extruder unit 300 may include a polymer inlet 106. In aspects, the polymer inlet 106 may be supported by a block 102. The polymer inlet 106 may be configured to receive adhesive, such as a filament adhesive and direct the adhesive into the extruder unit 300.

In aspects, the polymer processing device 100 may include an air supply valve 108 that may be configured to supply pressurized air to the dispensing valve unit 200 for operation of the dispensing valve unit 200 as described herein. In particular, the polymer processing device 100 may include a conduit 104 to deliver the pressurized air from the air supply valve 108 to the dispensing valve unit 200. The polymer processing device 100 may further include various connectors between the conduit 104 and the air supply valve 108 as well various connectors between the air supply valve 108 and the dispensing valve unit 200. Additionally, the air supply valve 108 may include at least one connector 116 for connecting to a pressurized air source. Accordingly, the air supply valve 108 may be configured to control a delivery of pressurized air from the pressurized air source to the dispensing valve unit 200. The air supply valve 108 may be implemented as a valve, a regulator, a solenoid valve, and/or the like for controlling the delivery of pressurized air from the pressurized air source to the dispensing valve unit 200. The various connectors related to the air supply valve 108 may be threaded connectors, push on connectors, and/or the like.

In aspects, the dispensing valve unit 200 may be attached to and moved by a movement mechanism (not shown), such as a robot, an x-y positioner, and/or the like. In particular the dispensing valve unit 200 may be moved by the movement mechanism in a pattern across a surface of the substrate.

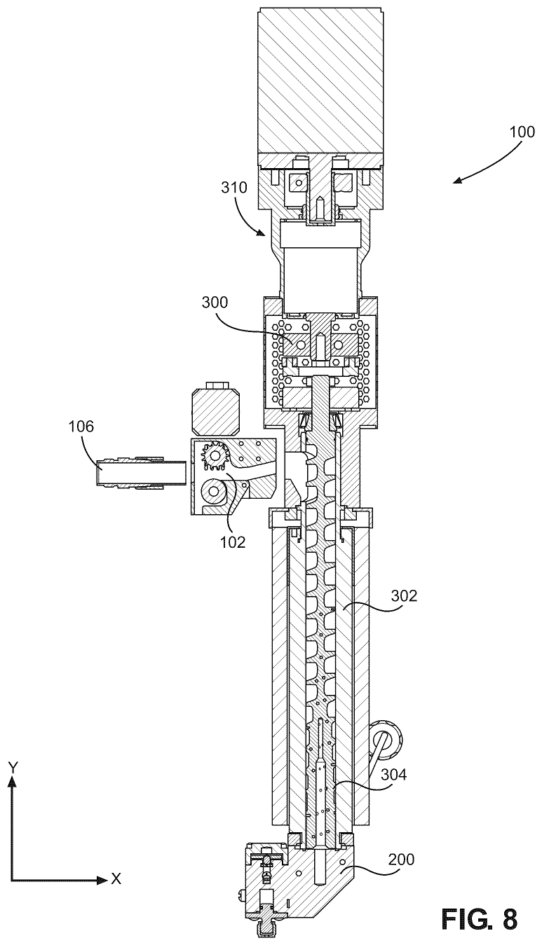

FIG. 8 illustrates a cross-sectional view of an exemplary implementation of polymer processing device according to FIG. 1.

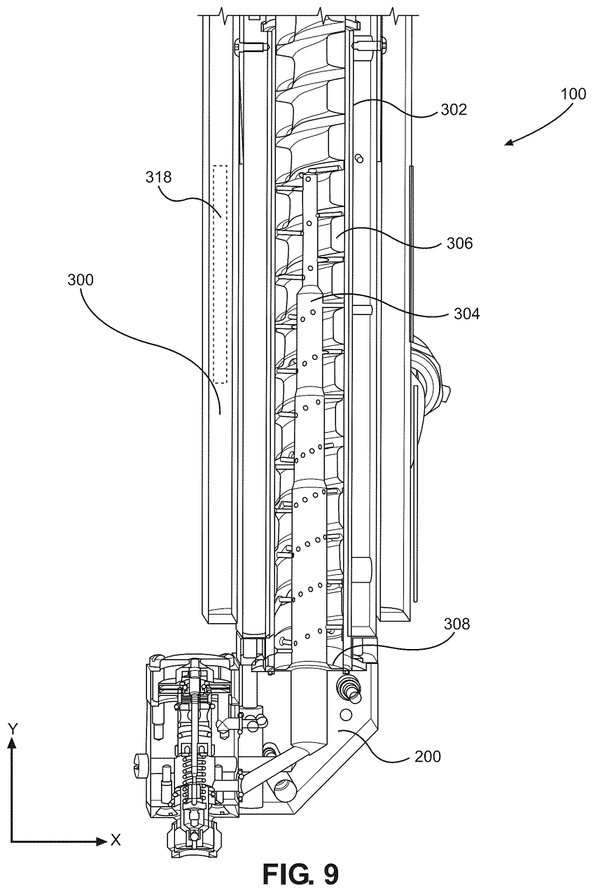

FIG. 9 illustrates a partial cross-sectional view of the polymer processing device according to FIG. 8.

As illustrated in FIG. 8 and FIG. 9, the extruder unit 300 may include an extruder barrel 302 and an extruder screw 304. In aspects, the extruder barrel 302 may be configured as a barrel used in a single screw extruder implementation of the extruder unit 300. Moreover, the extruder screw 304 may have a configuration as an extruder screw used in a single screw extruder. However, the extruder unit 300 may be implemented with any number of the extruder barrel 302, with any number of the extruder screw 304, with any type of extruder technology, and/or the like.

In aspects, the extruder screw 304 may include a shaft with a diameter that progressively increases along its length. In aspects, extending around the shaft of the extruder screw 304 may be helical flights for conveying molten material in the forward direction toward the dispensing valve unit 200 as the extruder screw 304 rotates within the extruder barrel 302. Additionally, in aspects notches may be provided in the helical flights of the extruder screw 304 to provide gripping lugs. The gripping lugs of the extruder screw 304 may provide additional edges that assist in catching and actively pulling a continuous filament adhesive through the inlet and into the extruder barrel 302.

With reference to FIG. 9, the extruder barrel 302 may have inner surface 306 that is cylindrical and engages the extruder screw 304 in an encircling relation. The inner surface 306 terminates in an outlet 308 at a distal end of the extruder barrel 302. The outlet 308 may be generally circular but may have any other suitable shape. The outlet 308 of the extruder unit 300 outputs the adhesive to the dispensing valve unit 200 and/or an intervening component of the polymer processing device 100.

The extruder barrel 302 and/or the extruder unit 300 may include one or more heating elements 318 for heating the inner surface 306 and melting the adhesive during a dispensing operation. In aspects, the one or more heating elements 318 may be embedded in a wall of the extruder barrel 302, the one or more heating elements 318 may be attached to a wall of the extruder barrel 302, and/or the one or more heating elements 318 may be otherwise in thermal communication with a wall of the extruder barrel 302 and/or the inner surface 306. In aspects, the inner surface 306 of the extruder barrel 302 can be grooved or otherwise textured to increase friction between the extruder barrel 302 and the extruded adhesive.

The polymer processing device 100 and/or the extruder unit 300 may include an inlet for receiving the adhesive. The inlet may be configured to receive the adhesive and guide the adhesive into the extruder unit 300, the extruder screw 304, and/or the extruder barrel 302 to be mixed and melted by the extruder unit 300 for subsequent delivery to the dispensing valve unit 200.

As illustrated in FIG. 8, the extruder unit 300 may include a drive mechanism 310 for rotating the extruder screw 304 about an axis parallel to the y-axis as illustrated in FIG. 8. Rotation of the extruder screw 304 with respect to the extruder barrel 302 mixes, melts, and/or moves the adhesive within the extruder unit 300. In particular, the extruder screw 304 moves the adhesive through the extruder unit 300 toward the outlet 308 and the dispensing valve unit 200.

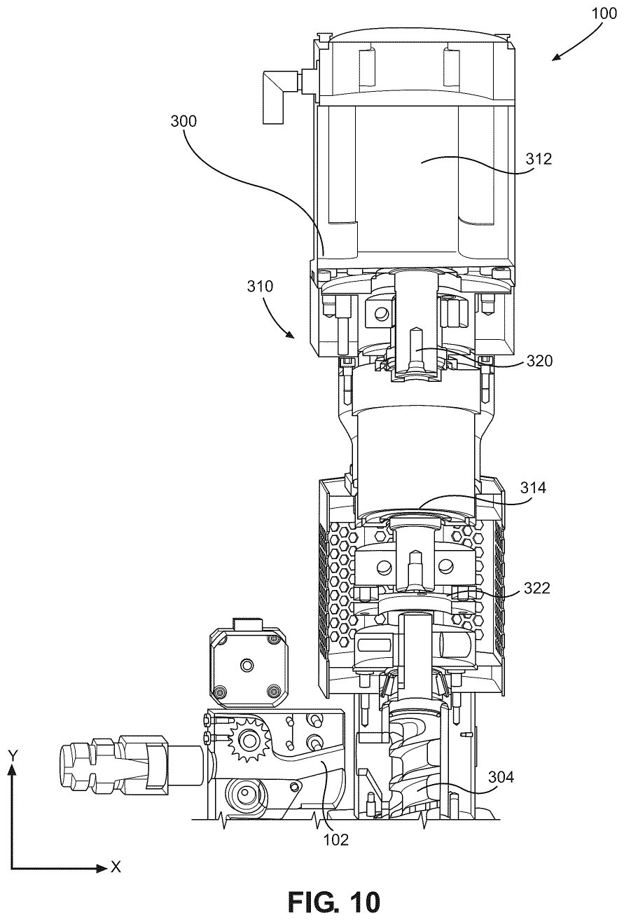

FIG. 10 illustrates a partial cross-sectional view of the polymer processing device according to FIG. 8.

With reference to FIG. 10, the drive mechanism 310 may include a gearbox 314 and a motor 312. The motor 312 may be implemented by any motor technology. The motor 312 may include a motor output 320, such as an output shaft having rotational connection portions, that delivers rotational torque generated by the motor 312 to the gearbox 314. The gearbox 314 may be configured to receive the rotational torque generated by the motor 312 and output rotational torque to a gearbox output 322 such as an output shaft having rotational connection portions. The gearbox output 322 may be rotationally engaged and/or connected to the extruder screw 304. Accordingly, operation of the motor 312 rotates the motor output 320, which in turn rotates the gearbox output 322, and which in turn rotates the extruder screw 304.

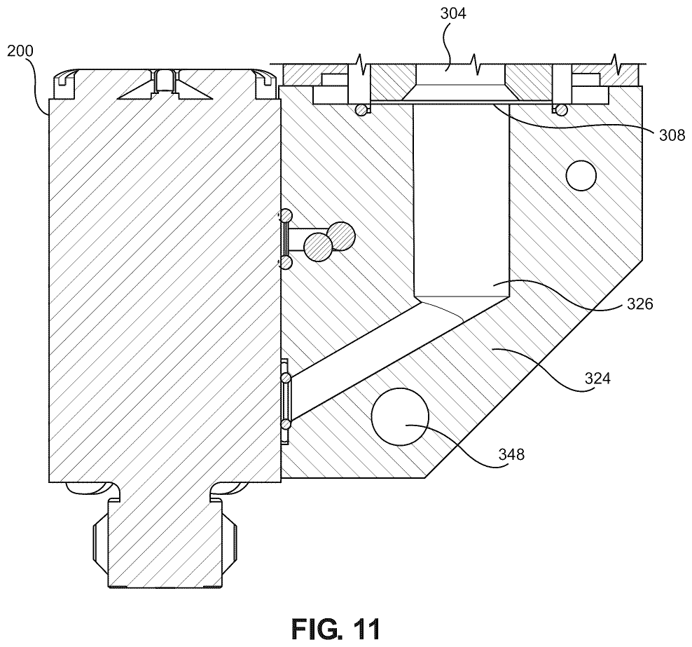

FIG. 11 illustrates a partial cross-sectional view of the polymer processing device according to FIG. 8.

In particular, FIG. 11 illustrates further exemplary details of one aspect of the dispensing valve unit 200. In this regard, the dispensing valve unit 200 of the polymer processing device 100 may be implemented as a pneumatic valve, an electrically operated valve, a solenoid operated valve, a hydraulically operated valve, and/or the like.

The dispensing valve unit 200 and/or the extruder unit 300 may include a manifold 324. The manifold 324 may guide adhesive from the extruder unit 300 that exits the outlet 308 to the dispensing valve unit 200. In this regard, the manifold 324 may include one or more conduits 326 that may guide the adhesive from the outlet 308 of the extruder unit 300 to the dispensing valve unit 200.

Additionally, the manifold 324 may include one or more heating elements 348. The implementation of the one or more heating elements 348 within the manifold 324 may heat the adhesive flowing through the manifold 324. In aspects, the one or more heating elements 348 may be embedded in a wall of the manifold 324, the one or more heating elements 348 may be attached to a wall of the one or more conduits 326, and/or the one or more heating elements 348 may be otherwise in thermal communication with a wall of the one or more conduits 326.

In this regard, the dispensing valve unit 200 may be implemented to operate as a positive displacement type valve that provides discrete dispensing of the adhesive from the extruder unit 300 and/or the manifold 324. More specifically, the polymer processing device 100 may be configured to operate the dispensing valve unit 200 to control the flow of adhesive for dispensing of the adhesive from the extruder unit 300 and/or the manifold 324. In this regard, the polymer processing device 100 may implement the dispensing valve unit 200 to open and allow flow of adhesive generated by the extruder unit 300 to flow through the manifold 324 and thereafter flow through the dispensing valve unit 200 for dispensing on a substrate; and the polymer processing device 100 may implement the dispensing valve unit 200 to close and stop a flow of adhesive generated by the extruder unit 300 and provided by the manifold 324 through the dispensing valve unit 200 for cutting off a dispensing of the adhesive on a substrate.

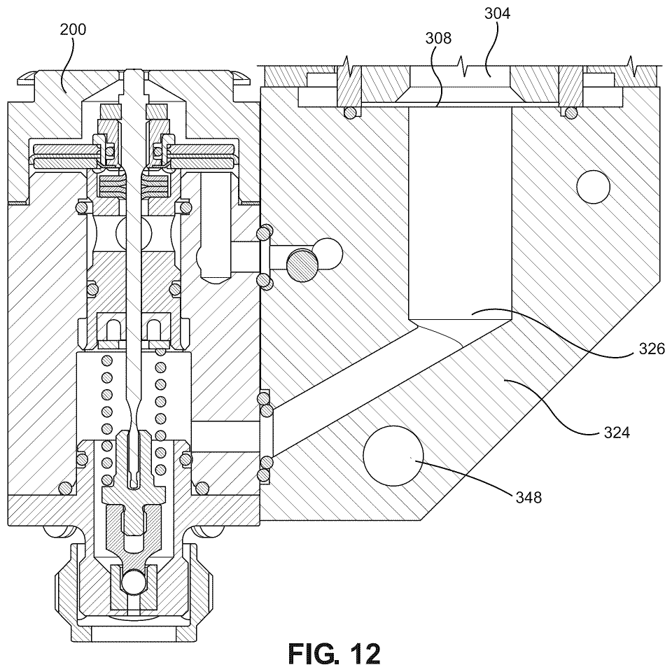

FIG. 12 illustrates a partial cross-sectional view of the polymer processing device according to FIG. 11.

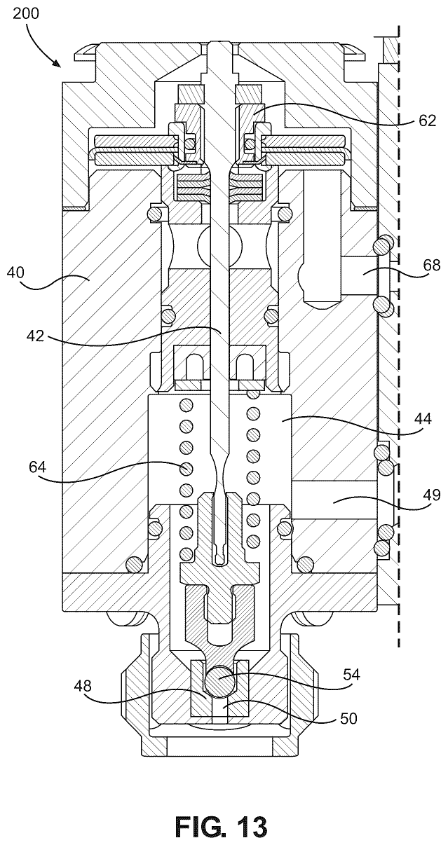

FIG. 13 illustrates a partial cross-sectional view of the dispensing valve unit 200 according to FIG. 12.

In particular, FIG. 12 and FIG. 13 illustrate further exemplary details of one aspect of the dispensing valve unit 200 implemented as a pneumatic valve connected to the manifold 324. In this exemplary implementation and with reference to FIG. 13, the dispensing valve unit 200 may include a module body 40, a valve stem 42 mounted for movement within the module body 40, and a supply chamber 44 that may be arranged in the module body 40. A valve seat 48 may be disposed between an inlet 49 and a discharge passageway 50. A valve element 54, which may be spherical, is positioned on the valve stem 42 for engaging the valve seat 48 when the dispensing valve unit 200 is in a closed condition. The valve element 54 is spaced from valve seat 48 when the dispensing valve unit 200 is in an open condition. In the open condition, the adhesive can flow from the inlet 49 through the supply chamber 44 and an annular gap between the valve element 54 and the valve seat 48 into the discharge passageway 50 for dispensing onto a substrate.

With continued reference to FIG. 13, the valve stem 42 is moved to provide the open and closed conditions by the selective application of air pressure to a piston assembly 62. A coil spring 64 applies a force to the valve stem 42 that urges the valve element 54 into a contacting relationship with the valve seat 48. The module body 40 may include an air inlet 68 that provides pressurized air to the piston assembly 62 sufficient to supply the open condition. The air inlet 68 may be in fluid communication with the air supply valve 108 by the conduit 104. When the dispensing valve unit 200 is in the open condition, a dispensing path may be defined from the extruder unit 300 and/or the outlet 308 to the one or more conduits 326, the inlet 49, the supply chamber 44, and the discharge passageway 50.

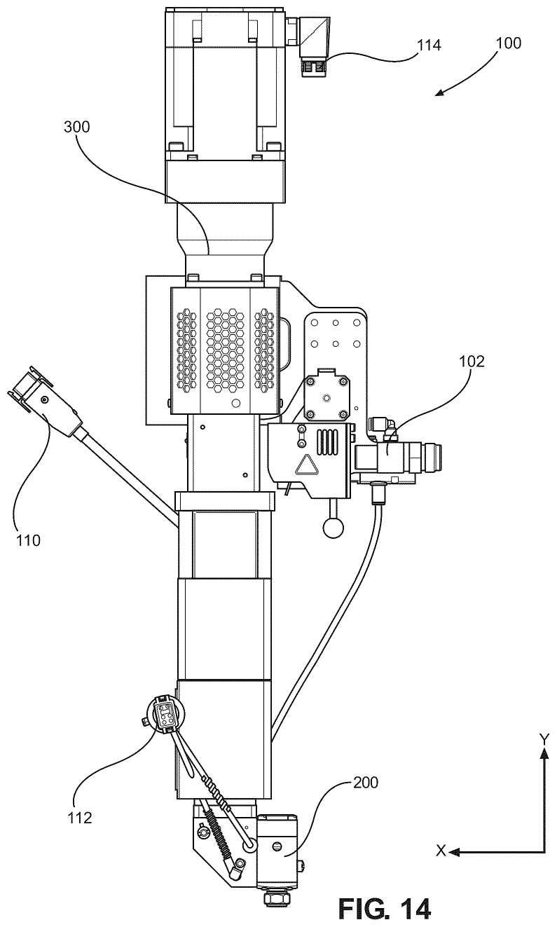

FIG. 14 illustrates a side view of a polymer processing device according to FIG. 1.

With reference to FIG. 14, the polymer processing device 100 may include electrical connections. In particular, the polymer processing device 100 may include electrical connections to a separate component to provide power, data, control, sensor information, and/or the like. In one aspect, the polymer processing device 100 may include an electrical connection 110, an electrical connection 112, an electrical connection 114. However, the polymer processing device 100 may include any number of electrical connections.

In aspects, the electrical connection 110 may connect to a separate component to provide power, data, control, sensor information, and/or the like to and/or from the polymer processing device 100 and/or the extruder unit 300. In aspects, the electrical connection 110 may include an electrical connector that may be implemented as a screw-on connector, a push on connector, and/or the like. In aspects, the electrical connection 110 may include wiring, insulation, and/or the like extending from the electrical connector to the polymer processing device 100 and/or the extruder unit 300.

In aspects, the electrical connection 112 may connect to a separate component to provide power, data, control, sensor information, and/or the like to and/or from the polymer processing device 100 and/or the dispensing valve unit 200. In aspects, the electrical connection 112 may include an electrical connector that may be implemented as a screw-on connector, a push on connector, and/or the like. In aspects, the electrical connection 112 may include wiring, insulation, and/or the like extending from the electrical connector to the polymer processing device 100, and/or the dispensing valve unit 200.

In aspects, the electrical connection 114 may connect to a separate component to provide power, data, control, sensor information, and/or the like to and/or from the polymer processing device 100, the extruder unit 300 and/or the drive mechanism 310. In aspects, the electrical connection 114 may include an electrical connector that may be implemented as a screw-on connector, a push on connector, and/or the like. In aspects, the electrical connection 114 may include wiring, insulation, and/or the like extending from the electrical connector to the polymer processing device 100, the extruder unit 300 and/or the drive mechanism 310.

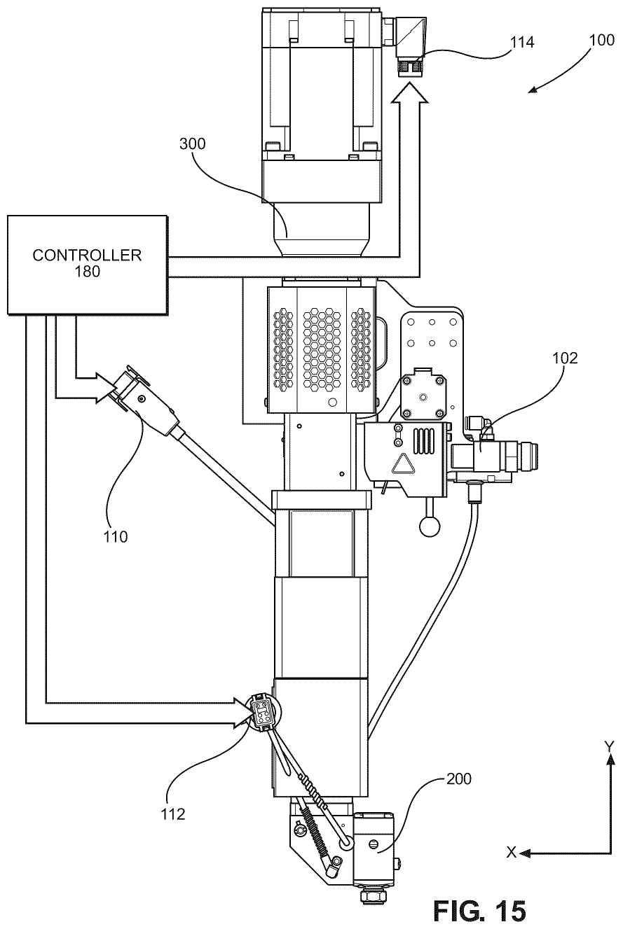

FIG. 15 illustrates a side view of a polymer processing device according to FIG. 1.

In aspects further described herein, the polymer processing device 100 may include a controller 180. The controller 180 may be implemented by one or more of a computer, a computer system, a controller, and/or the like. The controller 180 may include a plurality of computers, computer systems, controllers, and/or the like. Moreover, the controller may include a random-access memory, a read-only memory, an analog-to-digital device, a digital to analog device, drive circuits, filtering components, and/or the like.

The controller 180 may be connected to the electrical connection 110, the electrical connection 112, and/or the electrical connection 114. In aspects, the controller 180 may connect through the electrical connection 114 and may be configured to data, control, sensor information, and/or the like to and/or from the polymer processing device 100, the extruder unit 300 and/or the drive mechanism 310. In aspects, the controller 180 may connect through the electrical connection 114 and may be configured control the speed and/or torque of the drive mechanism 310, the motor 312, and/or the extruder screw 304.

In aspects, the controller 180 may connect through the electrical connection 110 and may be configured to data, control, sensor information, and/or the like to and/or from the polymer processing device 100, the extruder unit 300 and/or the like. In aspects, the controller 180 may connect through the electrical connection 110 and may be configured control the one or more heating elements 318.

In aspects, the controller 180 may connect through the electrical connection 112 and may be configured to data, control, sensor information, and/or the like to and/or from the polymer processing device 100, the dispensing valve unit 200 and/or the like. In aspects, the controller 180 may connect through the electrical connection 112 and may be configured control the dispensing valve unit 200, the air supply valve 108, and/or the like. In aspects, the controller 180 may connect through the electrical connection 112 and may be configured control the dispensing valve unit 200 to open and/or close.

In aspects, the polymer processing device 100 may include one or more sensors. The one or more sensors may include pressure sensors, position sensors, rotation sensors, movement sensors, temperature sensors, power sensors, voltage sensors, current sensors, and/or the like. In aspects, the pressure sensors may measure a pressure of adhesive in the extruder unit 300, the dispensing valve unit 200, and/or the like. In aspects, the position sensors may measure a position of the dispensing valve unit 200, and/or the like. The rotation sensors may sense a rotation of components of the extruder unit 300, and/or the like. In aspects, the temperature sensors may measure a temperature of the adhesive, components of the extruder unit 300, components of the dispensing valve unit 200, and/or the like.

In aspects, the controller 180 may be configured to operate components of the polymer processing device 100, components of the extruder unit 300, components of the dispensing valve unit 200, and/or the like. In particular, the controller 180 may provide drive signals to one or more components of the polymer processing device 100, one or more components of the dispensing valve unit 200, one or more components of the extruder unit 300, and/or the like for operation of these components. In aspects, the controller 180 may be configured to operate components of the polymer processing device 100, components of the extruder unit 300, components of the dispensing valve unit 200, and/or the like in response to sensor outputs from components of the polymer processing device 100, components of the extruder unit 300, components of the dispensing valve unit 200, and/or the like.

In aspects, the controller 180 may be configured to operate the extruder unit 300 to begin operation of the drive mechanism 310 and in particular the motor 312 to start rotation of the extruder screw 304 prior to operation of the dispensing valve unit 200. Thereafter, the rotation of the extruder screw 304 may start to increase a pressure of the adhesive within the extruder unit 300. In this regard, beginning operation of the extruder unit 604 readies the polymer processing device 100 for application of the adhesive by the dispensing valve unit 200.

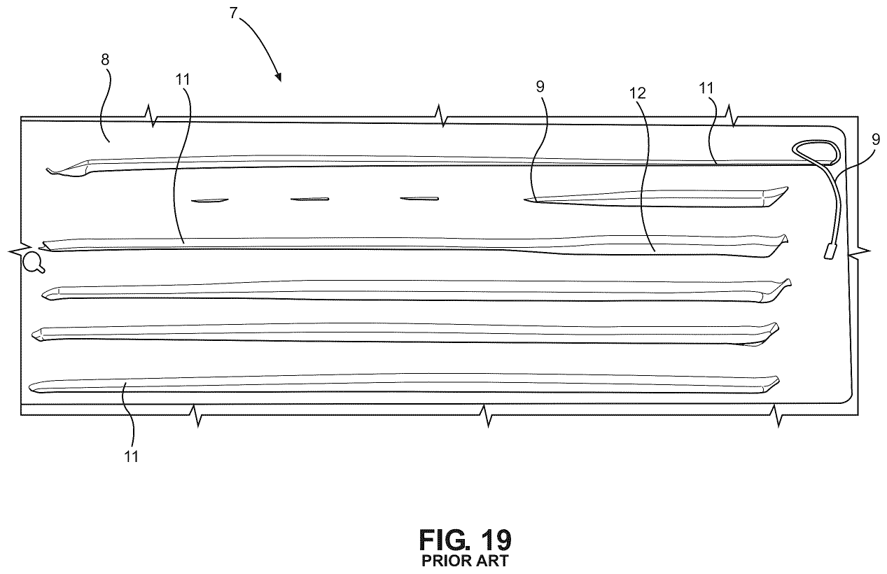

In this regard, the controller 180 may implement a delay time period that allows the extruder unit 300 to prepare the adhesive for utilization by the dispensing valve unit 200. Without implementation of a time delay, the adhesive initially applied by the polymer processing device 100 may have poor quality with reference to FIG. 19. The time delay may be a set amount of time, may be a dynamically adjustable amount of time responsive to the sensors of the polymer processing device 100, may be based on sensor outputs of the polymer processing device 100, and/or the like. In aspects, the controller 180 may implement a settable delay time period that allows the extruder unit 300 to prepare the adhesive for utilization by the dispensing valve unit 200. For example, in particular implementations of the extruder unit 300 and the dispensing valve unit 200, the delay time period may be 0-2000 ms, 10-50 ms, 50-100 ms, 100-200 ms, 200-500 ms, 500-1000 ms, or 1000-2000 ms. As another example, in particular implementations of the extruder unit 300 and the dispensing valve unit 200, the delay time period may be less than 50 ms, 100 ms, 200 ms, 500 ms, 500 ms, or 2000 ms. As another example, in particular implementations of the extruder unit 300 and the dispensing valve unit 200, the delay time period may be greater than 0 ms, 50 ms, 100 ms, 200 ms, 500 ms, 500 ms, or 1000 ms.

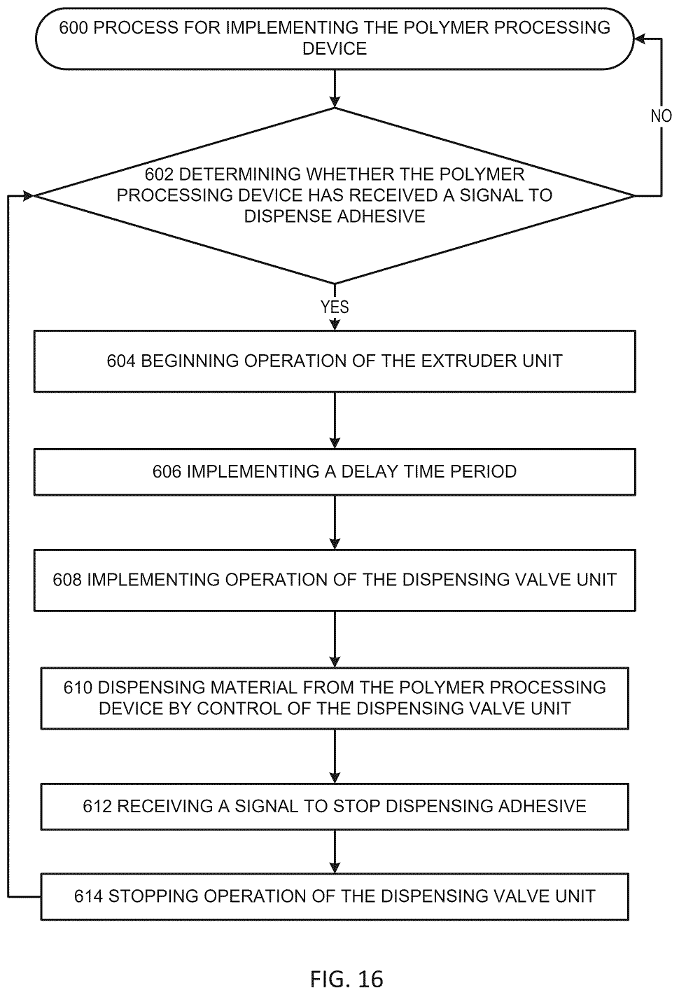

FIG. 16 illustrates an exemplary process for implementing a polymer processing device according to aspects of the disclosure.

In particular, FIG. 16 shows an exemplary process for implementing the polymer processing device 600. In this regard, the process for implementing the polymer processing device 600 may be a process for implementing the polymer processing device 100 of the disclosure.

In particular, it should be noted that the process for implementing the polymer processing device 600 is merely exemplary and may be modified consistent with the various aspects disclosed herein. It should be noted that the process for implementing the polymer processing device 600 may be performed in a different order consistent with the aspects described above. Moreover, the process for implementing the polymer processing device 600 may be modified to have more or fewer process steps consistent with the various aspects disclosed herein. Additionally, the process for implementing the polymer processing device 600 may be implemented by a computer, a computer system, a controller, the controller 180, and/or the like.

The process for implementing the polymer processing device 600 of the disclosure may include determining whether the polymer processing device has received a signal to dispense adhesive 602. In this regard, the determining whether the polymer processing device has received a signal to dispense adhesive 602 may include determining whether the polymer processing device 100 has received a signal to the dispense adhesive. In this regard, the determining whether the polymer processing device has received a signal to dispense adhesive 602 may include any one or more materials, structures, arrangements, processes, and/or the like as described herein.

The process for implementing the polymer processing device 600 of the disclosure may include beginning operation of the extruder unit 604. In this regard, the beginning operation of the extruder unit 604 may include beginning operation of the extruder unit 300 of the disclosure. In this regard, beginning operation of the extruder unit 604 may include any one or more materials, structures, arrangements, processes, and/or the like as described herein.

In aspects, the beginning operation of the extruder unit 604 may include the controller 180 operating the extruder unit 300 to begin operation of the drive mechanism 310 and in particular the motor 312 to start rotation of the extruder screw 304. Thereafter, the rotation of the extruder screw 304 may start to increase a pressure of the adhesive within the extruder unit 300. In this regard, the beginning operation of the extruder unit 604 readies the polymer processing device 100 for application of the adhesive by the dispensing valve unit 200.

The process for implementing the polymer processing device 600 of the disclosure may include implementing a delay time period 606. In this regard, the implementing a delay time period 606 may include implementing a delay time period with the controller 180. In this regard, implementing a delay time period 606 may include any one or more materials, structures, arrangements, processes, and/or the like as described herein.

In this regard, the implementing a delay time period 606 allows the extruder unit 300 to prepare the adhesive for utilization by the dispensing valve unit 200. Without implementation of a time delay, the adhesive initially applied by the polymer processing device 100 may have poor quality with reference to FIG. 19.

The process for implementing the polymer processing device 600 of the disclosure may include implementing operation of the dispensing valve unit 608. In this regard, the implementing operation of the dispensing valve unit 608 may include implementing operation of the dispensing valve unit 200. In this regard, implementing operation of the dispensing valve unit 608 may include any one or more materials, structures, arrangements, processes, and/or the like as described herein. In this regard, after the time delay, the polymer processing device 100 may be ready for application of adhesive and thereafter the dispensing valve unit 200 may be operated to apply adhesive to a substrate as described herein.

The process for implementing the polymer processing device 600 of the disclosure may include dispensing material from the polymer processing device by control of the dispensing valve unit 610. In this regard, the dispensing material from the polymer processing device by control of the dispensing valve unit 610 may include dispensing material from the polymer processing device 100 by control of the dispensing valve unit 200. In this regard, the dispensing material from the polymer processing device by control of the dispensing valve unit 610 may include any one or more materials, structures, arrangements, processes, and/or the like as described herein. In this regard, the dispensing valve unit 200 applies adhesive to a substrate as described herein.

The process for implementing the polymer processing device 600 of the disclosure may include receiving a signal to stop dispensing adhesive 612. In this regard, the receiving a signal to stop dispensing adhesive 612 may include receiving a signal to stop dispensing adhesive from the controller 180. In this regard, the receiving a signal to stop dispensing adhesive 612 may include any one or more materials, structures, arrangements, processes, and/or the like as described herein. In this regard, the controller 180 may send a signal to the dispensing valve unit 200 to stop application of adhesive to a substrate as described herein.

The process for implementing the polymer processing device 600 of the disclosure may include stopping operation of the dispensing valve unit 614. In this regard, the stopping operation of the dispensing valve unit 614 may include stopping operation of the dispensing valve unit 200. In this regard, the stopping operation of the dispensing valve unit 614 may include any one or more materials, structures, arrangements, processes, and/or the like as described herein. In this regard, the dispensing valve unit 200 may receive a signal from the controller 180 and stop application of adhesive to a substrate as described herein.

FIG. 17 illustrates application of adhesive to a substrate utilizing the polymer processing device of the disclosure.

In particular, an exemplary implementation the polymer processing device 100 was utilized in conjunction with the dispensing valve unit 200 to apply an adhesive 500 to a substrate 502. As illustrated in FIG. 17, the polymer processing device 100 when operated in conjunction the dispensing valve unit 200 applied the adhesive 500 to the substrate 502 with more controlled and/or more accurate start 506 of adhesive 500 at the end of a dispensing routine. Moreover, the polymer processing device 100 operated in conjunction the dispensing valve unit 200 provided a more controlled and/or more accurate start 506 of application of the adhesive 500 at the beginning of a dispensing routine. Moreover, the dispensing valve unit 200 addressed the ‘stretchiness’ of the material by the positive displacement operation of the dispensing valve unit 200, even in the molten state.

Additionally, with reference to FIG. 17, the dispensing valve unit 200 provided more precise metering of the adhesive 500 from the extruder unit 300 of the polymer processing device 100 as illustrated by the more uniform width of the adhesive 500.

In aspects of the disclosure, the adhesive utilized by the polymer processing device 100 may be a pressure sensitive adhesive. Pressure-sensitive adhesives are materials that adhere to a substrate upon application of pressure. They do not require solvent, water, or heat to provide an adhesive bond. State-of-the-art pressure-sensitive adhesives can achieve very high bond performance and are capable of replacing traditional mechanical fasteners in many industrial applications. These bonding solutions are also economical and easy to use.

Conventional pressure-sensitive adhesives are thin and flat, and generally dispensed in sheet or roll form. In certain applications, however, it can be advantageous for a pressure-sensitive adhesive to be formed in situ. In automotive bonding applications, for example, the bonding surfaces of a part can be non-planar to provide increased mechanical retention. Some parts can have a ribbed bonding surface that requires significant penetration of the pressure-sensitive adhesive into the ribbed structure to obtain adequate bond strength.

Moreover, the most common plastic used is thermoplastic olefin (“TPO”, sometimes referred to as “PP/EPDM”) which is a low surface energy plastic similar to polypropylene. Common pressure-sensitive adhesives do not achieve a high degree of “wet out” on these and similar plastics, resulting in reduced surface area between the adhesive and the substrate. Primers and other surface treatments can be used to improve “wet out,” but these add to the complexity and cost of bonding. For these reasons, bonding to non-planar low-surface-energy substrates remains a challenging technical problem.

In particular aspects, the polymer processing device 100, the dispensing valve unit 200, and/or the extruder unit 300 may be implemented as described below, may be implemented in a system as described below, may further include additional components and features as described below, and/or the like:

Accordingly, the disclosure has set forth an implementation of a polymer processing device configured to operate in conjunction the dispensing valve unit to apply an adhesive to a substrate with more controlled and/or more accurate cut off of adhesive at the end of a dispensing routine. Moreover, the disclosure has set forth an implementation of a polymer processing device that is configured to operate in conjunction the dispensing valve unit to provide more controlled and/or more accurate start of application of the adhesive at the beginning of a dispensing routine. Moreover, the disclosure has set forth an implementation of a dispensing valve unit that is configured address the ‘stretchiness’ of the material by the positive displacement operation of the dispensing valve unit, even in the molten state.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items. Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features discussed herein may be used alone or in any combination depending on the needs and preferences of the user. This has been a description of illustrative aspects and embodiments the present invention, along with the preferred methods of practicing the present invention as currently known. However, the invention itself should only be defined by the appended claims.

1. A polymer processing device comprising:
an extruder unit configured to receive, melt, and mix an adhesive; and
a dispensing valve unit configured to dispense adhesive onto a substrate,
wherein the dispensing valve unit comprises a positive displacement type valve that provides discrete dispensing of the adhesive.

2. The polymer processing device according to claim 1 wherein the dispensing valve unit is configured to be implemented as a pneumatic valve, an electrically operated valve, a solenoid operated valve, and/or a hydraulically operated valve.

3. The polymer processing device according to claim 1 wherein the dispensing valve unit is configured to control a flow of adhesive for dispensing of the adhesive generated by the extruder unit.

4. The polymer processing device according to claim 1 wherein the dispensing valve unit is configured to close and stop a flow of adhesive generated by the extruder unit.

5. The polymer processing device according to claim 1 wherein the extruder unit comprises an extruder barrel and an extruder screw.

6. The polymer processing device according to claim 5 further comprising a manifold comprising one or more conduits configured to guide the adhesive from an outlet of the extruder unit to the dispensing valve unit.

7. The polymer processing device according to claim 5 wherein the extruder unit comprises an outlet at a distal end of the extruder barrel.

8. The polymer processing device according to claim 5 wherein the extruder unit comprises one or more heating elements configured to melt the adhesive during a dispensing operation.

9. The polymer processing device according to claim 5
wherein the extruder unit comprises an inlet configured to receive the adhesive; and
wherein the extruder screw, and/or the extruder barrel are configured to mix and melt the adhesive and provide the adhesive to the dispensing valve unit.

10. The polymer processing device according to claim 9 wherein the extruder unit comprises a drive mechanism for rotating the extruder screw to move the adhesive through the extruder unit to the dispensing valve unit.

11. The polymer processing device according to claim 10 wherein the drive mechanism comprises a gearbox and a motor.

12. The polymer processing device according to claim 6 wherein the manifold comprises one or more heating elements.

13. The polymer processing device according to claim 1 wherein the dispensing valve unit is implemented as a pneumatic valve.

14. The polymer processing device according to claim 1 wherein the dispensing valve unit comprises a module body, a valve stem mounted for movement within the module body, and a supply chamber that may be arranged in the module body.

15. The polymer processing device according to claim 14
wherein the dispensing valve unit comprises a valve seat and a valve element; and
wherein the valve stem is moved to provide open and closed conditions by a selective application of air pressure to a piston assembly.

16. The polymer processing device according to claim 13 further comprising air supply valve that may be configured to supply pressurized air to the dispensing valve unit.

17. The polymer processing device according to claim 1 further comprising electrical connections configured to transfer power, data, control, and/or sensor information to or from one or more components of the dispensing valve unit and/or one or more components of the extruder unit.

18. The polymer processing device according to claim 10 further comprising a controller configured to provide drive signals to one or more components of the dispensing valve unit and/or one or more components of the extruder unit.

19. The polymer processing device according to claim 18 wherein the controller is configured to operate the extruder unit to begin operation of the drive mechanism prior to operation of the dispensing valve unit.

20. The polymer processing device according to claim 18 wherein the controller is configured to operate the extruder unit to begin operation of the drive mechanism and after a time delay begin operation of the dispensing valve unit.

21. A polymer processing device comprising:
an extruder unit configured to receive, melt, and mix an adhesive; and
a dispensing valve unit configured to dispense adhesive onto a substrate,
wherein the dispensing valve unit is configured to be implemented as a pneumatic valve, an electrically operated valve, a solenoid operated valve, and/or a hydraulically operated valve.

22-39. (canceled)

40. A process of implementing a polymer processing device comprising:
implementing an extruder unit configured to receive, melt, and mix an adhesive; and
implementing a dispensing valve unit configured to dispense adhesive onto a substrate,
wherein the dispensing valve unit is configured to be implemented as a pneumatic valve, an electrically operated valve, a solenoid operated valve, and/or a hydraulically operated valve.

41-58. (canceled)
